(19) United States
(12) Patent Application Publication
(10) Pub. No.: US 2026/0261162 A1
(43) Pub. Date: Sep. 3, 2026

(54) TURBINE ENGINE MODULE PROVIDED WITH AN ELECTRIC MACHINE

(71) Applicant: SAFRAN AIRCRAFT ENGINES, Paris (FR)

(72) Inventors: Frederic MONTIN, Moissy-Cramayel (FR); Adrian FLORESCU, Moissy-Cramayel (FR); Alexandre Jean-Marie TAN-KIM, Moissy-Cramayel (FR); Romain TRUCO, Moissy-Cramayel (FR)

(21) Appl. No.: 19/165,083

(22) PCT Filed: Mar. 27, 2024
(86) PCT No.: PCT/FR2024/050395

§ 371 Date: Sep. 12, 2025

(30) Foreign Application Priority Data
Mar. 31, 2023 (FR) FR2303173

(51) Int. Cl. H02K 1/12; H02K 1/22; H02K 7/00

(52) U.S. Cl. CPC H02K 1/12; H02K 1/22; H02K 7/003

(57) ABSTRACT

A module for a turbine engine, in particular for an aircraft turbine engine, includes a shaft extending in an axial direction and an electric machine including a rotor rotatably coupled to the shaft of the module, the rotor comprising a disc and magnetic elements arranged regularly around the periphery of the disc; and a stator rigidly attached to a casing of the module including a ring and coils distributed annularly inside the ring of the stator, the coils being arranged outside the magnetic elements of the rotor in a radial direction, wherein each coil is radially movable between a first end position and a second end position, each coil being held in the first position in normal operation and moved toward the second end position in the event of the rotor moving radially towards the coil of the stator.

### TECHNICAL FIELD

The technical field of the invention is that of turbine engine equipped with an electric machine.

The present invention relates in particular to an aircraft turbine engine module equipped with an electric machine.

### PRIOR ART

The technical background includes in particular the documents EP 3 029 814 A2, WO 2012/159108 A2, US 2015/0171722 A1 and EP 2 369 720 A1.

The aeronautical world is now asking many questions about the relevance of using hybrid engines for commercial aviation. The use of electrical energy is now considered not only to meet the functions of the aircraft but also to electrify the functions of the turbine engine. This has led to the study of hybrid engine architecture solutions, combining fossil fuel energy and electrical energy to drive the propulsion section (fan or turbine of the turbine engine) and power certain engine and/or aircraft functions.

In particular, these architectures can be based on a high dilution ratio and reducer architecture, or a multiple-body architecture (two or three). In these architectures, the turbine engine comprises a low pressure body and a high pressure body, each body comprising a shaft connecting a rotor of a compressor to a rotor of a turbine.

It is known to equip an aircraft turbine engine with an electric machine. We recall that an electric machine is an electromechanical device based on the electromagnetism allowing the conversion of electrical energy into work or mechanical energy for example. This process is reversible and can be used to produce electricity.

Thus, depending on the final use of an electric machine, the following terms are used:
generator for an electric machine producing electrical energy from mechanical energy,
motor for an electric machine producing mechanical energy from electrical energy.

An electric machine can also comprise in motor mode according to a first operating phase and in generator mode according to a second operating phase distinct from the first.

The electric machines we are talking about here are electricity generators or reversible machines that can also work as an electric motor and are then able to start a turbine or fan shaft or at least provide it with additional power. They can complement the electricity generator usually found on the accessory gearbox (AGB), which draws power from the high-pressure casing if the electric machine is integrated into the low-pressure body of a turbine engine.

Several installation areas are possible but the advantages and the disadvantages of each are numerous and diverse (problem of mechanical integration of the machine, temperature resistance of the machine, accessibility of the machine, etc.). For example, the patent application FR 3 087 823 A1 describes the installation of an electric machine downstream of a fan. The electric machine can also be installed downstream of a turbine shaft and driven by this shaft.

The electric machine is generally annular in shape and comprises a rotor and a stator. The rotor and stator each have a generally cylindrical shape extending around the axis of the turbine engine. The rotor generally comprises a disc and magnetic elements (e.g. permanent magnets) arranged regularly around the periphery of the disc, while the stator comprises a ring supporting coils distributed regularly in an annular pattern inside the ring of the stator. The stator surrounds the rotor. In other words, the ring of the stator and disc of the rotor are concentric and the ring of the stator is radially external to the disc of the rotor. In other words, the coils are arranged radially outside with respect to the magnetic elements.

In nominal operation, two types of force are applied to the rotor of an electric machine: a torque (resistive or driving, depending on the operating conditions), and a radial force.

In special operating conditions, such as high switching loads, imbalance or other malfunctions, the rotor of the electric machine may move radially relative to the stator. For example, in the case of an electric machine arranged downstream of a fan, the rotor of the electric machine is secured to a disc of the fan by means of a flange and screws. If a vane is lost from the fan disc, the disc becomes severely unbalanced and starts to orbit due to the resulting imbalance. This imbalance can cause misalignment, which in turn causes local closure of the air gap in the electric machine. Since the eccentricity associated with the loss of the vane is much greater than the clearance between the magnetic elements of the rotor and the coils of the stator of the electric machine, contact occurs between said magnetic elements and said coils of the electric machine.

Today, the air gap in an electric machine is calculated to prevent any contact between the magnetic elements of the rotor and the coils of the stator. This imposes a number of constraints:
either a large air gap to cope with significant switching maneuvering or failures,
or as complete a mechanical decoupling as possible between the electric machine and the rest of the turbine engine, which imposes integration constraints as described in the patent FR 3 087 823.

However, a large air gap impairs the performance of the electric machine, and mechanical decoupling imposes significant integration constraints (addition of decoupling elements, positioning of the assembly downstream of the turbine engine, etc.).

The objective of the present invention is to overcome at least some of the problems mentioned above. In particular, this invention offers a solution that eliminates the risk of contact between the magnetic elements of the rotor and the coils of the stator in order to avoid damaging the electric machine or modifying the dynamic situation of the turbine engine, which ultimately leads to a reduction in the air gap and a gain in performance.

### SUMMARY OF THE INVENTION

To this end, the invention relates to a module for a turbine engine, in particular for an aircraft turbine engine, comprising a shaft extending in an axial direction and an electric machine comprising:
a rotor coupled in rotation with the shaft of the module, the rotor comprising a disc and magnetic elements arranged regularly around the periphery of the disc, and
a stator secured to a casing of the module comprising a ring and coils distributed in an annular manner inside the ring of the stator, the coils being arranged outside the magnetic elements of the rotor in a radial direction, characterized in that each coil is radially movable between a first extreme position and a second extreme position, each coil being maintained in the first position in normal operation and moved to the second extreme position in the event of the rotor moving radially towards the coil of the stator.

The invention thus allows the radial movement of the elements carried by the stator of an electric machine in order to reduce the air gap, increase the performance of the electric machine while remaining robust against rotor/stator clearance consumption. In other words, the invention allows the risk of contact between the magnetic elements of the rotor and the coils of the stator to be eliminated in order to prevent damage to the electric machine or changes to the dynamic situation of the turbine engine.

During normal operation, the elements supported by the stator, i.e. the coils, are held in the extreme position, i.e. a position in which all the elements supported by the stator are at the same distance from the rotor of the electric machine. In other words, the air gap of the electric machine is constant.

During abnormal operation, for example under load, imbalance or other malfunctions, the elements supported by the stator are pushed radially outward by the rotor. The movement of the elements supported by the stator radially outward allows the suppression of the risk of contact between the magnetic elements of the rotor and the coils of the stator. As a result, neither the electric machine suffers any damage nor is the dynamic situation of the turbine engine altered.

Thus, the invention allows the reduction of the air gap of the electric machine during normal operation, resulting in improved performance while remaining robust in special operating conditions such as high load factors. This gain in performance can be translated into a gain in mass/size for equivalent power or a gain in power for equivalent mass.

In addition, the integration constraints on the electric machine are reduced, as it is no longer necessary to decouple the electric machine completely from the rest of the turbine engine or to position it in a position that is only slightly affected by load factors.

The module for a turbine engine according to the invention may comprise one or more of the following characteristics, taken in isolation from one another or in combination with one another in any technically possible combinations:
the stator has an inner surface and supports return elements, each shaped to hold an associated coil in the first position in normal operation, each return element being arranged between the inner surface of the stator and the associated coil;
each return element is a spring or a leaf, a first end of which is connected to the inner surface of the stator and a second end opposite the first end is connected to the coil;
the stator comprises for each coil at least one slide configured to guide the coil in rectilinear translation in a radial direction between the first and second extreme positions;
each coil comprises two through-holes each receiving a rod forming a slide, each rod having a circular cross-section and extending substantially radially between a first end secured to the inner surface of the stator and a second end shaped to form an abutment for the coil in the first extreme position;
each coil comprises a through-hole receiving a rod forming a slide, the rod extending radially between a first end secured to the inner surface of the stator and a second end shaped to form an abutment for the coil in the first extreme position, the rod having a non-circular, preferably rectangular or oblong cross-section;
each coil is arranged in a gutter forming a slide, the gutter has a cylindrical body complementary in shape to the associated coil and shaped to guide the coil in rectilinear translation in the radial direction between the first and second extreme positions, the cylindrical body extending radially between a first end secured to the inner surface of the stator and a second end shaped to form an abutment for the coil in the first extreme position;
the stator comprises, for each coil, an arm comprising a first end secured to the coil and a second end connected to the inner surface of the stator by a pivot connection having a pivot axis extending perpendicularly to the axial direction, the arm being shaped so that its pivoting causes the coil to move between the first extreme position and the second extreme position;
the rotor comprises, for each magnetic element, at least one main contact element and the stator comprises, for each coil, at least one secondary contact element, each main contact element of the rotor being arranged opposite a secondary contact element of the stator, the main contact element and the secondary contact element being shaped to avoid contact between the coil of the stator and the magnetic element of the rotor in the event of the rotor moving radially towards the coil of the stator;
each main contact element and each secondary contact element is made of bronze or a non-stick polymer such as Teflon®;
the air gap of the electric machine defined by the distance in a radial direction between the magnetic elements and the coils in normal operation is between 0.5 mm and 10 mm.

The invention also relates to a turbine engine, in particular an aircraft turbine engine, comprising at least a module according to the invention and as described above.

Preferably, the module is a fan module comprising a fan and the electric machine is mounted coaxially downstream of the fan, the rotor of the electric machine being rotationally coupled to the fan.

Alternatively, the module is a turbine module and the electric machine is mounted coaxially downstream of a turbine casing.

### BRIEF DESCRIPTION OF FIGURES

The invention will be better understood and other details, characteristics and advantages of the present invention will become clearer from the following description made by way of non-limiting example and with reference to the attached drawings, in which:

FIG. 1 is a schematic view in axial section of an example of an aircraft turbine engine to which the invention applies, the example illustrated being a turbine engine with a high bypass ratio and reduction gear;

FIG. 2 is a schematic view in longitudinal section of an electric machine fitted to a module according to the invention, in a first embodiment and in normal operation;

FIG. 3 shows a schematic cross-sectional view of the electric machine of FIG. 2 in normal operation;

FIG. 4 is a schematic view of the cross-section of an element supported by the stator of the electric machine of FIGS. 2 and 3 in a plane perpendicular to the radial direction;

FIG. 5 is a schematic view of the cross-section of an element supported by the stator of the electric machine of FIGS. 2 and 3 in a plane perpendicular to that of FIG. 4;

FIG. 6 is a schematic longitudinal sectional view of the electric machine of FIG. 2 in abnormal operation, in which the rotor is eccentric;

FIG. 7 is a schematic cross-sectional view of the electric machine of FIG. 6 in abnormal operation;

FIG. 8 is a schematic view in longitudinal section of an electric machine fitted to a module according to the invention, in a second embodiment and in normal operation;

FIG. 9 is a schematic view of the cross-section of an element supported by the stator of the electric machine of FIG. 8 in a plane perpendicular to the radial direction;

FIG. 10 is a schematic view of a variant of the cross-section of an element supported by the stator of the electric machine of FIG. 8 in a plane perpendicular to the radial direction;

FIG. 11 is a schematic view of the cross-section of an element supported by the stator of the electric machine of FIG. 8 in a plane perpendicular to that of FIGS. 9 and 10;

FIG. 12 is a schematic longitudinal sectional view of the electric machine of FIG. 8 in abnormal operation;

FIG. 13 is a schematic view in longitudinal section of an electric machine fitted to a module according to the invention, in a third embodiment and in normal operation;

FIG. 14 is a schematic longitudinal sectional view of the electric machine of FIG. 13 in abnormal operation;

FIG. 15 is a schematic view in longitudinal section of an electric machine fitted to a module according to the invention, in a fourth embodiment and in normal operation; and

FIG. 16 is a schematic longitudinal section view of the electric machine in FIG. 15 in abnormal operation.

The elements with the same functions in the different implementations have the same references in the figures.

### DESCRIPTION OF THE EMBODIMENTS

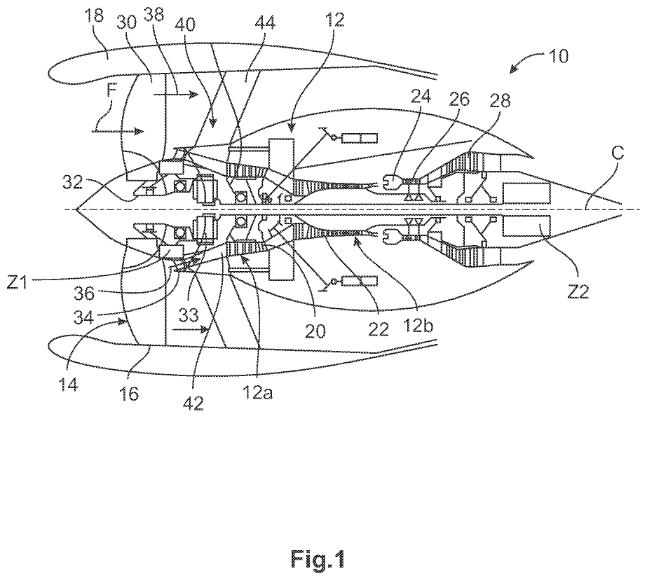

Reference is first made to FIG. 1, which shows schematically a double-body, double-flow aircraft turbine engine 10 to which the invention applies. Of course, the invention can be applied to other types of turbine engine equipped with an electric machine, for example a turboprop engine, without going beyond the scope of the invention.

The turbine engine 10 has a longitudinal axis C around which its various components extend.

The turbine engine 10 conventionally comprises a gas generator 12, upstream of which is arranged a fan 14. The fan 14 is surrounded by a fan casing 16 which is surrounded by a nacelle 18 that extends around and along a major portion of the gas generator 12.

The gas generator 12 here comprises two bodies, namely a low-pressure body 12a or LP and a high-pressure body 12b or HP. Each body comprises a compressor and a turbine.

In the present invention, and in general, the terms “upstream” and “downstream” are defined in relation to a main direction F of fluid flow inside the turbine engine, and here along the longitudinal axis C, i.e. from left to right with reference to FIG. 1.

From upstream to downstream, the gas generator 12 comprises a low-pressure compressor 20, a high-pressure compressor 22, a combustion chamber 24, a high-pressure turbine 26 and a low-pressure turbine 28.

The longitudinal axis C is the axis of rotation of the movable element of the turbine engine 10, and in particular the turbines 26, 28.

The fan 14 comprises an annular row of vanes 30 driven in rotation by a fan shaft 32 which is connected to the rotor of the low-pressure body 12a by means of a reduction gear 33. The gas flow passing through the fan (arrow F) is separated upstream of the gas generator 12 by an annular nose 34 into a radially inner annular flow, called the primary flow 36, which feeds the gas generator 12, and a radially outer annular flow, called the secondary flow 38, which flows between the gas generator 12 and the nacelle 18 and provides most of the thrust of the turbine engine.

An inlet casing 40 structurally connects the gas generator 12 to the fan casing 16 and the nacelle 18. The inlet casing 40 comprises an annular array of radially inner arms 42 extending into the primary flow 36, and an annular array of radially outer compressor stator vanes 44 (of the OGV type) extending into the secondary flow 38. The arms 42 are generally limited in number (less than ten) and are tubular and passed through by auxiliaries. The number of vanes 44 (OGV) is generally higher than ten.

The turbine engine comprises a module 100 according to the invention comprising a shaft extending in an axial direction A, parallel to the longitudinal axis of the turbine engine and an electric machine 110.

The zone Z1 represents a zone located between the fan disc 32 and the reduction gear 33, in which the electric machine can be installed.

The zone Z2 represents another zone located downstream of the low-pressure turbine 28, in which the electric machine can also be installed.

In the description, the expressions “inner” or “inside” and “outer” or “outside” are used without limitation in reference to the radial distance from the longitudinal axis C around which the turbine engine extends, the expression “inner” defining a zone radially closer to the longitudinal axis of the nacelle, as opposed to the expression “outer”. Furthermore, in the description and the claims, the terms axial, radial and transverse will be adopted with reference to the trihedron A, R, T shown in the figures, the axial axis A being parallel to the longitudinal axis of the turbine engine.

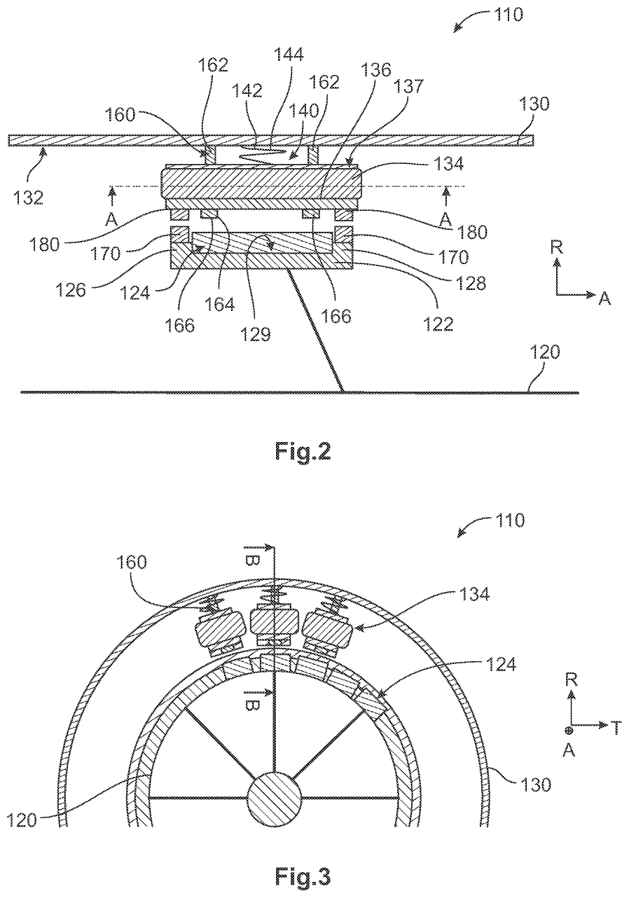

With reference to FIGS. 2 to 7 and 10 to 12, the electric machine 110 is generally annular in shape and comprises a rotor 120 and a stator 130.

The rotor 120 has a generally cylindrical shape extending circumferentially around an axis of rotation coincident with the axis C of the turbine engine. The rotor is coupled to the shaft of the module 100, i.e. the shaft of the fan if the electric machine is installed downstream of the fan (Zone Z1) or the shaft of the low-pressure turbine if the electric machine is installed downstream of it (Zone Z2).

The rotor 120 comprises an annular disc 122 and magnetic elements 124 arranged regularly around the periphery of the disc 122. The magnetic elements 124 are permanent magnets, for example.

In the examples illustrated in FIGS. 2 to 7 and 10 to 12, the disc 122 comprises an upstream circumferential edge 126 known as the “upstream edge” and a downstream circumferential edge 128 known as the “downstream edge”. The upstream 126 and downstream 128 edges extend radially outwards from a circumferential bottom 129 of the disc. The magnetic elements 124 are in contact with the circumferential bottom 129 of the disc. More specifically, the magnetic elements 124 are radially outwards with respect to the circumferential base 129 supporting the magnetic elements 124.

In addition, the magnetic elements 124 are arranged between the upstream 126 and the downstream 128 edges of the disc 122 of the rotor 120.

Generally, the magnetic elements 124 are shrunk onto the disc 122 of the rotor 120.

The stator 130 comprises a ring which also has a generally cylindrical shape extending circumferentially around the axis C of the module and the turbine engine. The stator 130 is secured to a module casing, for example the fan casing 16 (zone Z1).

The ring of the stator 130 comprises an inner surface 132, i.e. a surface radially inwards.

The ring of the stator 130 supports coils 134 distributed annularly inside the ring.

The stator surrounds the rotor. In other words, the ring of the stator and disc of the rotor are concentric and the ring of the stator is radially outwards to the disc of the rotor. The coils 134 are arranged opposite the magnetic elements 124 of the rotor 120 in a radial direction R. In other words, the magnetic elements 124 of the rotor 120 are radially inwards with respect to the coils 134 of the stator 130.

Each coil 134 comprises a radially inner surface 136 known as the “inner surface” and a radially outer surface 137 known as the “outer surface”.

Each coil 134 is formed by a conducting wire wound around a support, the support being secured to the ring of the stator 130.

According to the invention, each coil 134 is radially movable between a first extreme position and a second extreme position. Each coil 134 is held in the first position during normal operation and moved to the second extreme position when the rotor 120 moves radially toward the coil 134 of the stator 130. The second extreme position is thus radially outside the first extreme position.

According to the invention, the air gap of the electric machine defined by the distance in a radial direction between the magnetic elements and the coils in normal operation is between 0.5 mm and 10 mm.

FIGS. 2 to 7 refer to a first embodiment of a module according to the invention.

According to this first embodiment, the stator comprises, for each coil, at least one slide configured to guide the coil in rectilinear translation in the radial direction R between the first and second extreme positions.

More specifically, according to this first embodiment, the stator 130 comprises, for each coil 134, two slides configured to guide the coil in rectilinear translation in the radial direction R between the first and second extreme positions. FIGS. 2 and 3 illustrate the electric machine in normal operation, i.e., when the rotor 120 is not subjected to any radial displacement due, for example, to imbalances. In this case, the coils 134 of the stator 130 are in their first position. More specifically, these are held in the first extreme position in normal operation by return elements. Each return element is supported by the inner surface 132 of the stator 130, more precisely by the inner surface 132 of the ring of the stator 130. Each return element is arranged between the inner surface 132 of the stator 130 and the associated coil 134 so as to return the coil to the first extreme position.

In the example shown, the return element is a return spring 140, a first end 142 of which is connected to the stator 130 and a second end 144 opposite the first end 142 is connected to the radially outer surface 137 of the coil, more precisely to the radially outer surface of the support around which the conductor wire is wound. In normal operation, the spring 140 is stressed in order to maintain the coil 134 in the first extreme position, i.e. in a position remote from the inner surface 132 of the stator in a radial direction R. The radial stiffness of the springs 140 must be adapted to be as low as possible, in order not to influence the dynamic situation and to limit the contact forces, while preserving the support of the elements under the various loads (vibratory, operating loads) and with respect to the electromagnetic radial resultant.

In the example shown, the return element is a spring 140. Alternatively, the return element may be a leaf, one end of which is connected to the stator and a second end opposite the first end is connected to the coil and shaped to hold the coil in the first extreme position.

In addition, each coil 134 comprises two through-holes 150. More specifically, each hole 150 is formed in the support of the coil 134. Each through-hole 150 receives a rod 160 forming a slide. Each rod 160 extends substantially radially between a first end 162 secured to the stator 130 and a second end 164 opposite the first end 162. The second end 164 is shaped to form an abutment 166 for the coil 134 in the first extreme position.

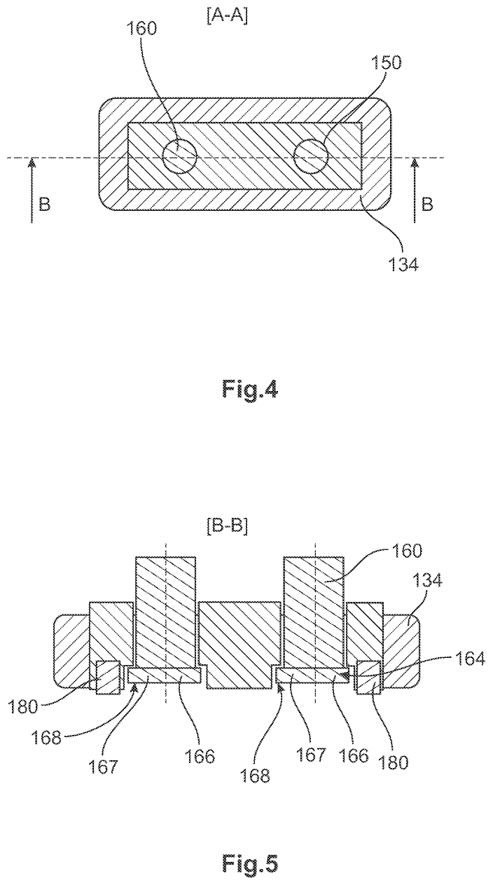

Referring to FIG. 4, which illustrates a cross-sectional view along the plane A-A (visible in FIG. 2) of the stator, and in particular of a coil 134, in a plane perpendicular to the radial axis R, each rod 160 has a circular cross-section. The two rods 160 are arranged in the same plane perpendicular to the axis T, i.e. extending in the axial A and radial R directions.

FIG. 5 shows a cross-sectional view along the plane B-B (visible in FIGS. 3 and 4) of the stator 130. Each rod 160 has a second end 164 with a protrusion 167 of greater diameter than the rod at the first end 162 to form an abutment 166 for the coil.

In the example shown in FIG. 2, the protrusion 167 is in contact with the inner surface 136 of the coil 134. Alternatively, the coil 134 may comprise two recesses 168 (visible in FIG. 5) each configured to receive the protrusion of a rod such that the protrusion 167 is in contact with a bottom of a recess 168 and the protrusion is fully seated within the recess 168 such that the protrusion does not project inwards beyond the inner surface of the coil. This characteristic allows advantageously to prevent any contact with any magnetic elements in the rotor and therefore to prevent damage to the latter even during normal operation.

In this embodiment, the stator 130 comprises two slides per coil to prevent the latter from rotating around a radial axis.

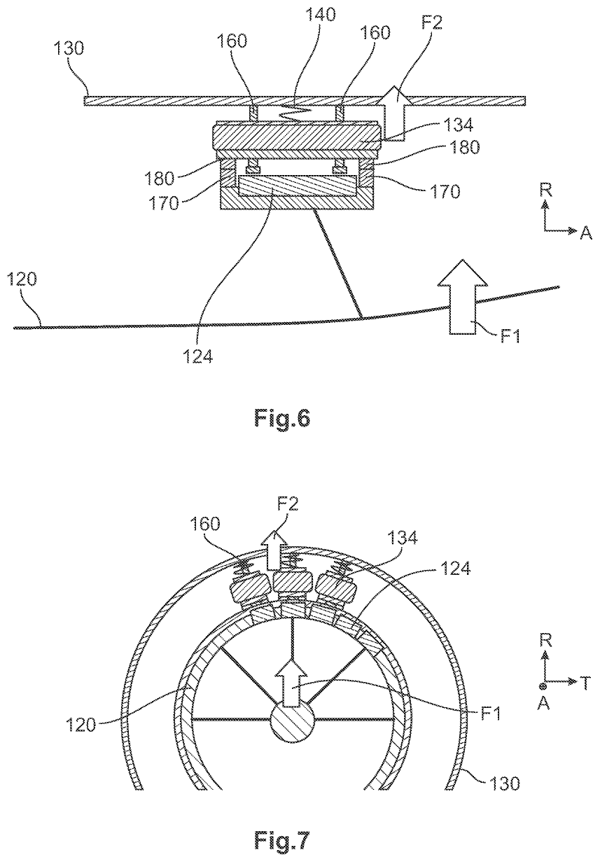

Furthermore, in order to guarantee the absence of contact between the magnetic elements 124 of the rotor 120 and the elements supported by the stator 130, the coils 134 in the example shown, the rotor 120 advantageously comprises, for each magnetic element 124, at least one main contact element 170, and the stator 130 also comprises, for each element supported by the stator, the coils 134 in the example shown, at least one secondary contact element 180. Each main contact element 170 of the rotor 120 is arranged opposite a secondary contact element 180 of the stator 130. The main contact element 170 and the secondary contact element 180 are shaped to prevent contact between the coil 134 of the stator 130 and the magnetic element 124 of the rotor 120 in the event of the rotor moving radially towards the coil of the stator (FIGS. 6 and 7).

FIGS. 6 and 7 illustrate the electric machine in abnormal operation, i.e. when the rotor 120 undergoes radial displacement, shown by the arrow F1, caused, for example, by unbalance. In this case, the coils 134 of the stator, towards which the rotor moves, are displaced radially outwards along the arrow F2 towards their second extreme position as soon as associated main contact elements 170 of the rotor 120 are in contact with corresponding secondary contact elements 180 of the stator 130. The return element, the spring 140 in the example shown, is even more constrained, here compressed.

The movement of the elements supported by the stator, the coils 134 in the example shown, radially outwards following contact of the main contact elements 170 of the rotor with the corresponding secondary contact elements 180 of the stator 130 eliminates any contact between the magnetic elements 124 of the rotor and the coils 134 of the stator. As a result, neither the electric machine suffers any degradation nor the dynamic situation of the turbine engine changes.

In the embodiment illustrated in FIGS. 2 to 7, a first main contact element 170 known as the “upstream main contact element” is supported by a radially outer surface of the upstream edge 126 of the disc 122 of the rotor and a second main contact element 170 known as the “downstream main contact element” is supported by a radially outer surface of the downstream edge 128 of the disc 122 of the rotor.

In a similar way, a first secondary contact element 180 known as the “upstream secondary contact element” is supported by an upstream edge 138 of the radially inner surface 136 of the support of the coil 134 of the rotor and a second secondary contact element 180 known as the “downstream secondary contact element” is supported by a downstream edge 139 of the support of the radially inner surface 136 of the coil 134 of the rotor 130.

Preferably, each main contact element 170 and each secondary contact element 180 is made of a material with a low coefficient of friction, preferably bronze or a non-stick polymer such as Teflon®, in order to limit heating and degradation.

The main contact elements can also be shrunk, screwed or glued to the disc 122 of the rotor. Similarly, the secondary contact elements can be secured to the support of the coil by shrink-fitting, screwing or gluing.

Thus, in abnormal operation, the upstream main contact element 170 is in contact with the upstream secondary contact element 180 and the downstream main contact element 170 is in contact with the downstream secondary contact element 180, avoiding any direct contact between the coils 134 and the magnetic elements 124 which could have damaged them.

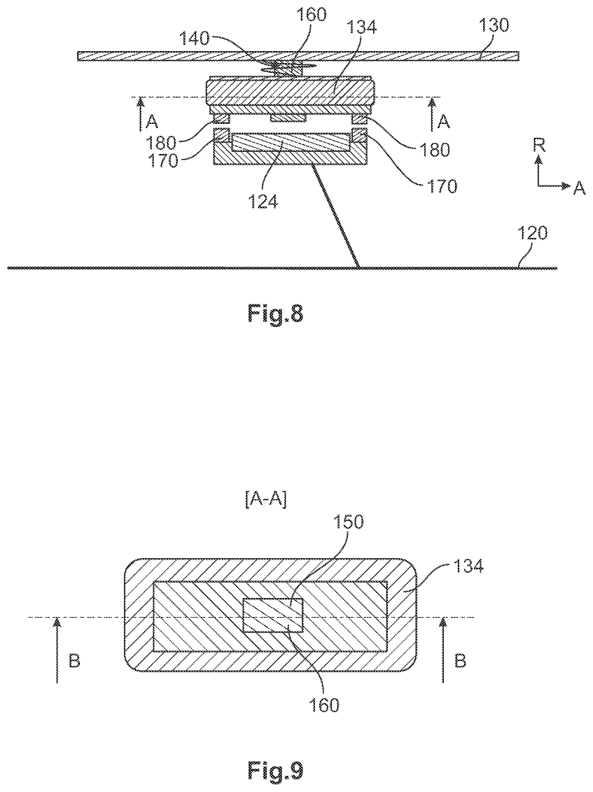

FIGS. 8 to 11 show a second embodiment which differs from the first in that the stator 130 comprises a single slide for each coil 134, the slide being configured to guide the coil in a rectilinear line in a radial direction between the first and second extreme positions. FIG. 8 shows the electric machine in normal operation, i.e. when the rotor is not subject to any radial displacement due to unbalance, for example. In this case, the coils 134 of the stator are in their first position. As in the first embodiment, the coils are held in the first extreme position during normal operation by return elements.

In the example shown, the return element is a spring 140. However, the return element may be an elastic leaf as in the first embodiment.

Each coil 134 comprises a single through-hole 150 which receives a rod 160 forming a slide. More specifically, the single hole 150 is formed in the support of the coil around which the conductive wire is wound. The rod 160 extends substantially radially between a first end 162 secured to the stator 130 and a second end 164 opposite the first end 162. The second end 164 is shaped to form an abutment 166 for the coil 134 in the first extreme position.

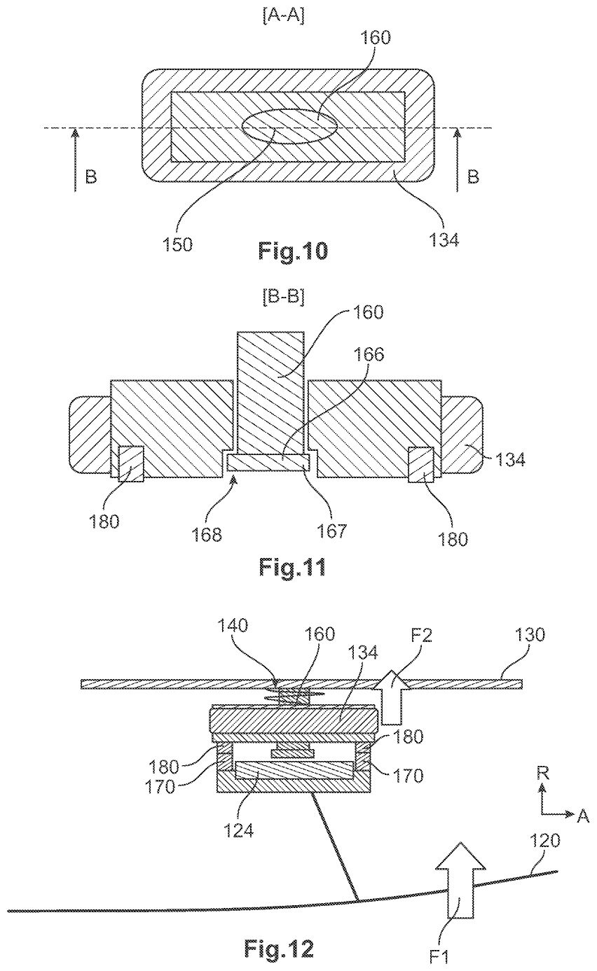

In order to prevent rotation of the coil 134 about the axis of the rod 160, the rod 160 has a non-circular cross-section. In particular, the rod 160 has a rectangular cross-section as shown in FIG. 9 or an oblong cross-section as shown in FIG. 10. FIGS. 9 and 10 illustrate a cross-sectional view along the plane A-A (visible in FIG. 8) of the stator, and in particular of a coil 134, in a plane perpendicular to the radial axis R.

FIG. 11 shows a cross-sectional view along the plane B-B (visible in FIGS. 9 and 10) of the stator 130. As in the first embodiment, the rod 160 has a second end 164 with a protrusion 167 of greater diameter than that of the rod at the first end 162 to form an abutment 166 for the coil.

In the example shown in FIG. 8, the protrusion 167 is in contact with the inner surface 136 of the coil 134. Alternatively, the coil 134 may comprise a recess 168 (visible in FIG. 11) configured to receive the protrusion of the rod such that the protrusion 167 is in contact with a bottom of a recess 168 and the protrusion is fully housed within the recess 168 such that the protrusion does not project inwardly beyond the inner surface of the coil. This characteristic allows advantageously to prevent contact with any magnetic elements in the rotor and therefore to prevent damage to the latter even during abnormal operation.

In a similar way to the first embodiment, in order to guarantee the absence of contact between the magnetic elements 124 of the rotor 120 with the elements supported by the stator 130, the coils 134 in the illustrated example, the rotor 120 advantageously comprises for each magnetic element 124 at least one main contact element 170 and the stator 130 also comprises for each element supported by the stator, the coils 134 in the illustrated example, at least one secondary contact element 180. The description of these elements for the first embodiment also applies to the second embodiment.

Thus, in abnormal operation (FIG. 12), the upstream main contact element 170 is in contact with the upstream secondary contact element 180 and the downstream main contact element 170 is in contact with the downstream secondary contact element 180, avoiding any direct contact between the coils 134 and the magnetic elements 124 which could have damaged them.

FIG. 12 illustrates the electric machine in abnormal operation, i.e. when the rotor 120 undergoes a radial displacement, shown as arrow F1, due to unbalance, for example. In this case, the coils 134 of the stator, towards which the rotor moves, are displaced radially outwards along the arrow F2 towards their second extreme position as soon as associated main contact elements 170 of the rotor 120 are in contact with corresponding secondary contact elements 180 of the stator 130. The return element, the spring 140 in the example shown, is further compressed.

The movement of the elements supported by the stator, the coils 134 in the example shown, radially outwards following contact of the main contact elements 170 of the rotor with the corresponding secondary contact elements 180 of the stator 130 eliminates any contact between the magnetic elements 124 of the rotor and the coils 134 of the stator. As a result, neither the electric machine suffers any degradation nor the dynamic situation of the turbine engine changes.

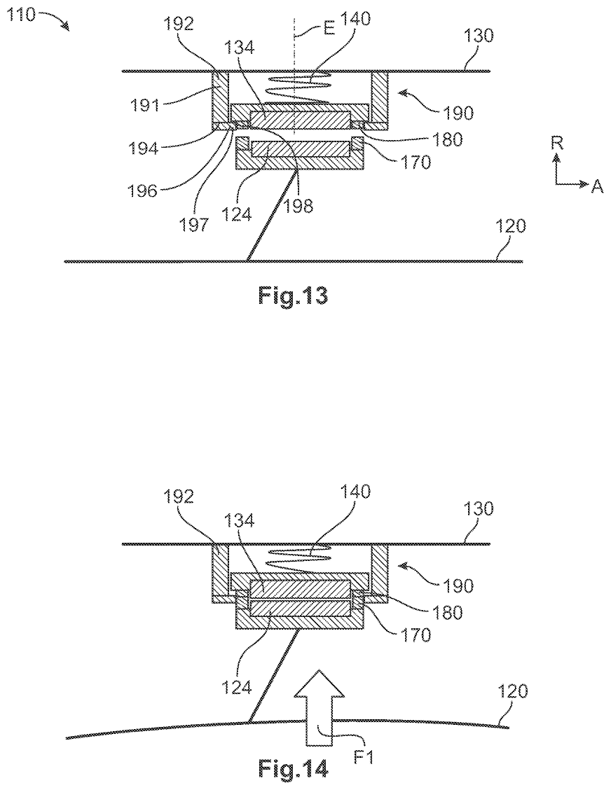

FIGS. 13 and 14 show a third embodiment which differs from the first in that the stator 130 comprises a single slide for each coil 134, the slide being configured to guide the coil in rectilinear translation in a radial direction between the first and second extreme positions.

In this third embodiment, each slide associated with a coil is formed by a gutter 190 housing said coil. The gutter 190 is shaped to guide the coil in a rectilinear translation in a radial direction between the first and second extreme positions. In fact, the gutter 190 comprises a cylindrical body 191 with a main axis designated E and a shape complementary to the associated coil 134 and configured to guide the coil in rectilinear translation in the radial direction between the first and second extreme positions. The cylindrical body 191 extends radially between a first end 192 secured to the stator 130 and a second end 194 shaped to form an abutment 196 for the coil 134 in the first extreme position.

In the example shown in FIGS. 13 and 14, the second end 192 of the cylindrical body 191 has a protrusion 197 extending from an inner surface of the cylindrical body 191 towards the inside thereof, i.e. towards the main axis E of the cylindrical body. The protrusion extends around the entire inner circumference of the second end 192 of the cylindrical body 191 to a free edge(s) 198 depending on the shape of the protrusion. The protrusion extends continuously or in regularly distributed portions around the circumference. As a result, the protrusion is shaped to retain the coil 134 in the cylindrical body in the first extreme position. In other words, the inner dimension D1 of the protrusion, i.e. the dimension in the axial direction between the free edges 198 of the protrusion 197 is smaller than the dimension D2 of the coil in the same axial direction. In the example shown, the dimension D2 is the dimension of the support of the coil 134 which is wider than the wound part of the coil.

As with the first and second embodiments, in order to guarantee the absence of contact between the magnetic elements 124 of the rotor 120 and the elements supported by the stator 130, the coils 134 in the example shown, the rotor 120 advantageously comprises, for each magnetic element 124, at least one main contact element 170, and the stator 130 also comprises, for each element supported by the stator, the coils 134 in the example shown, at least one secondary contact element 180. The description of these elements for the first embodiment also applies to the third embodiment.

Thus, in the abnormal operation illustrated in FIG. 14, following the movement of the rotor towards the stator, the upstream main contact element 170 is in contact with the upstream secondary contact element 180 and the downstream main contact element 170 is in contact with the downstream secondary contact element 180, avoiding any direct contact between the coils 134 and the magnetic elements 124 which could have damaged them.

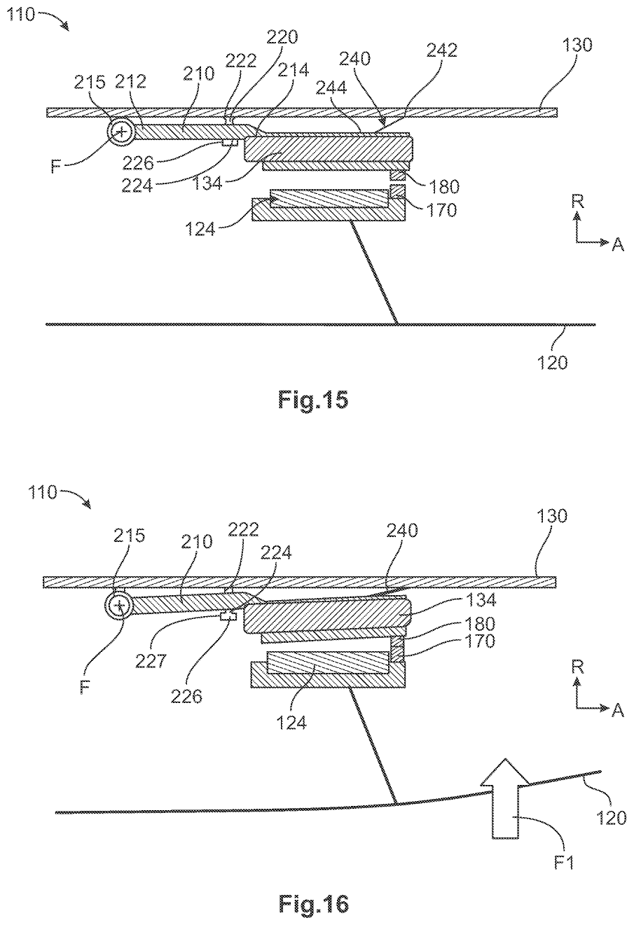

FIGS. 15 and 16 show a fourth embodiment in which the stator 130 comprises, for each coil 134, an arm 210 comprising a first end 212 secured to the coil 134 and a second end 214 connected to the stator by a pivot link 215. The pivot connection 215 has a pivot axis F extending perpendicularly to the axial direction A and to the radial direction R. The arm 210 is shaped so that pivoting it causes the coil to move between the first extreme position and the second extreme position.

In the example shown, the pivot link 215 is arranged upstream of the coil. However, it can be arranged downstream from it.

In fact, the arm 210 is configured to pivot around the pivot axis F between a first position corresponding to the first extreme position of coil 134 and a second position corresponding to the second extreme position of the coil 134.

Thus, the stator 130 further comprises a rod 220 extending radially between a first end 222 secured to the inner surface 132 of the stator 130 and a second end 224 shaped to form an abutment 226 for the arm 210 in the first position.

For example, the arm 210 comprises a through-hole at its second end 214 receiving the rod 220 and the second end 224 of the rod 220 comprises a protrusion 227 of greater diameter/dimension than that of the rod at its first end 222 in order to form an abutment 226 for the arm 210.

FIG. 15 shows the electric machine in normal operation, i.e. when the rotor is not subject to any radial displacement due to unbalance, for example. In this case, the coils of the stator are in their first extreme position. More specifically, these are held in the first extreme position in normal operation by return elements. Each return element is supported by the inner surface 132 of the stator 130. Each return element is arranged between the inner surface 132 of the stator 130 and the associated coil 134 so as to hold the coil in the first extreme position.

In the example shown, the return element is a leaf 240, a first end 242 of which is connected to the stator 130 and a second end 244 opposite the first end is connected to the coil 134 and shaped to return the coil to the first extreme position.

However, alternatively, the return element may be a return spring, one end of which is connected to the stator and a second end opposite the first end is connected to the radially outer surface of the coil to return the coil to its first extreme position.

Furthermore, in order to guarantee the absence of contact between the magnetic elements 124 of the rotor 120 and the elements supported by the stator 130, the coils 134 in the example shown, the rotor 120 advantageously comprises at least one main contact element 170 for each magnetic element 124 and the stator 130 also comprises, at least one secondary contact element 180, for each element supported by the stator, the coils 134 in the example shown. Each main contact element 170 of the rotor 120 is arranged opposite a secondary contact element 180 of the stator 130. The main contact element 170 and the secondary contact element 180 are shaped to prevent contact between the coil 134 of the stator 130 and the magnetic element 124 of the rotor 120 in the event of the rotor moving radially towards the coil of the stator (FIG. 16).

FIG. 16 illustrates the electric machine in abnormal operation, i.e. when the rotor is subject to radial displacement, as shown by the arrow F1, due to unbalance, for example. In this case, the coils 134 of the stator, towards which the rotor moves, are displaced radially outwards along the arrow towards their second extreme position as soon as associated main contact elements 170 of the rotor 120 are in contact with corresponding secondary contact elements 180 of the stator 130. The return element, the leaf 240 in the example shown, is even more constrained than in the first extreme position (FIG. 14).

More specifically, the coils 134 of the stator, towards which the rotor moves, are pivoted about the pivot axis F, causing a radial outward movement of said coils.

The displacement of the elements supported by the stator, the coils 134 in the example shown, radially outwards, following contact of the main contact elements 170 of the rotor with the corresponding secondary contact elements 180 of the stator 130, greatly reduces or even eliminates any risk of contact between the magnetic elements 124 of the rotor and the coils 134 of the stator. As a result, neither the electric machine suffers any degradation nor the dynamic situation of the turbine engine changes.

In the embodiment illustrated in FIGS. 15 and 16, a main contact element 170 known as the “downstream main contact element” is supported by a radially outer surface of the downstream edge 128 of the disc 122 of the rotor.

Similarly, a secondary contact element 180 known as the “downstream secondary contact element” is supported by a downstream edge 139 of the radially inner surface 136 of the coil 134 of the rotor 130.

Preferably, each main contact element 170 and each secondary contact element 180 is made of a material with a low coefficient of friction, preferably bronze or a non-stick polymer such as Teflon® in order to limit heating and damage.

The main contact elements can also be shrunk, screwed or glued to the disc 122 of the rotor. Similarly, the secondary contact elements can be secured to the support of the coil by shrink-fitting, screwing or gluing.

The invention as described above thus enables the radial displacement of the elements supported by the stator of an electric machine in order to reduce the air gap and increase performance, while at the same time being robust in terms of rotor/stator clearance consumption.

In fact, the inventors have estimated that the invention allows a 20% reduction in the air gap compared with an electric machine of the prior art, thus saving around 5% in the mass of the electric machine at equivalent power.

1. A module for a turbine engine, in particular for an aircraft turbine engine, comprising a shaft extending in an axial direction and an electric machine comprising:
a rotor coupled in rotation with the shaft of the module, the rotor comprising a disc and magnetic elements arranged regularly around the periphery of the disc, and
a stator secured to a casing of the module comprising a ring and coils distributed in an annular manner inside the ring of the stator, the coils being arranged outside the magnetic elements of the rotor in a radial direction,
wherein each coil is radially movable between a first extreme position and a second extreme position, each coil being maintained in the first position in normal operation and moved to the second extreme position in the event of the rotor moving radially towards the coil of the stator.

2. The module according to claim 1, wherein the stator has an inner surface and supports return elements, each shaped to hold an associated coil in the first position in normal operation, each return element being arranged between the inner surface of the stator and the associated coil.

3. The module according to claim 2, wherein each return element is a spring or a leaf, a first end of which is connected to the inner surface of the stator and a second end opposite the first end is connected to the coil.

4. The module according to claim 1, wherein the stator comprises for each coil at least one slide configured to guide the coil in rectilinear translation in a radial direction between the first and second extreme positions.

5. The module according to claim 4, wherein each coil comprises two through-holes each receiving a rod forming a slide, each rod having a circular cross-section and extending substantially radially between a first end secured to the inner surface of the stator and a second end shaped to form an abutment for the coil in the first extreme position.

6. The module according to claim 4, wherein each coil comprises a through-hole receiving a rod forming a slide, the rod extending radially between a first end secured to the inner surface of the stator and a second end shaped to form an abutment for the coil in the first extreme position, the rod having a non-circular, preferably rectangular or oblong cross-section.

7. The module according to claim 4, wherein each coil is arranged in a gutter forming a slide, the gutter has a cylindrical body of complementary shape to the associated coil and shaped to guide the coil in rectilinear translation in the radial direction between the first and second extreme positions, the cylindrical body extending radially between a first end secured to the inner surface of the stator and a second end shaped to form an abutment for the coil in the first extreme position.

8. The module according to claim 1, wherein the stator comprises, for each coil, an arm comprising a first end secured to the coil and a second end connected to the inner surface of the stator by a pivot connection having a pivot axis extending perpendicularly to the axial direction the arm being shaped so that its pivoting causes the coil to move between the first extreme position and the second extreme position.

9. The module according to claim 1, wherein the rotor comprises, for each magnetic element, at least one main contact element and the stator comprises, for each coil, at least one secondary contact element, each main contact element of the rotor being arranged opposite a secondary contact element of the stator, the main contact element and the secondary contact element being shaped to avoid contact between the coil of the stator and the magnetic element of the rotor in the event of the rotor moving radially towards the coil of the stator.

10. A turbine engine, in particular an aircraft turbine engine, comprising at least one module according to claim 1.
